(19) United States
(12) Patent Application Publication
(10) Pub. No.: US 2026/0008299 A1
(43) Pub. Date: Jan. 8, 2026

(54) OMNIDIRECTIONAL ROTATION DRIVE APPARATUS

(71) Applicants: HYUNDAI MOTOR COMPANY, Seoul (KR); KIA CORPORATION, Seoul (KR)

(72) Inventors: Jun Ho Seong, Hwaseong-si (KR); Sang Woo Hwang, Hwaseong-si (KR)

(73) Assignees: HYUNDAI MOTOR COMPANY, Seoul (KR); KIA CORPORATION, Seoul (KR)

(21) Appl. No.: 18/943,298

(22) Filed: Nov. 11, 2024

(30) Foreign Application Priority Data
Jul. 3, 2024 (KR) 10-2024-0087215

(51) Int. Cl. B60B 19/00; B60B 19/12; B60K 17/04

(52) U.S. Cl. CPC B60B 19/003; B60B 19/12; B60K 17/046

(57) ABSTRACT

An omnidirectional rotation drive apparatus includes: a knuckle connected to a vehicle body, a main wheel drive shaft rotatably supported on the knuckle, a sub-wheel drive shaft rotatably supported on the main wheel drive shaft, a wheel body fixed to the main wheel drive shaft to rotate simultaneously with the main wheel drive shaft, sub-wheel units rotatably supported on the wheel body, and gear units connected to the sub-wheel drive shaft to transmit rotational force from the sub-wheel drive shaft to the sub-wheel units. In particular, the sub-wheel units are rotated based on an angular velocity difference between the main wheel drive shaft and the sub-wheel drive shaft.

### CROSS-REFERENCE TO RELATED APPLICATION

This application claims under 35 U.S.C. § 119(a) the benefit of and priority to Korean Patent Application No. 10-2024-0087215, filed on Jul. 3, 2024, the entire contents of which are incorporated herein by reference.

### BACKGROUND

### (a) Technical Field

The present disclosure relates to an omnidirectional rotation drive apparatus. More particularly, it relates to an omnidirectional rotation drive apparatus including a plurality of sub-wheels.

### (b) Background Art

Recently, in the field of electric vehicles, development has been underway on an omnidirectional wheel structure that enables straight driving without changing a steering angle. The omnidirectional wheel is also called as an omni wheel, which means a wheel that can move in all directions. Due to its unique structure, the omni wheel enables special movements that cannot be achieved with conventional wheels, such as rotation in place, horizontal movement to the left, and horizontal movement to the right of a transportation device.

However, conventionally developed omni wheel structures have a discontinuous sub-wheel structure and low power transmission efficiency, and may not be applied to vehicles using the existing suspension structure.

The above information disclosed in this Background section is provided only to enhance understanding of the background of the present disclosure and therefore it may contain information that does not form the prior art that is already known to a person of ordinary skill in the art.

### SUMMARY

The present disclosure has been made in an effort to solve the above-described problems associated with the prior art, and it is an object of the present disclosure to provide an omnidirectional rotation drive apparatus that enables a vehicle to move in a first direction through a wheel body and allows the vehicle to move in a second direction by selectively driving sub-wheels.

It is another object of the present disclosure to provide an omnidirectional rotation drive apparatus that includes gear units located inside a wheel body, which is coupled to a first motor and a second motor, thereby enabling selective driving of sub-wheels.

The objects of the present disclosure are not limited to the above-mentioned objects, and other objects not mentioned herein should be clearly understood by those having ordinary skill in the art from the following description and should be more clearly understood from embodiments of the present disclosure. Further, the objects of the present disclosure may be realized by means and combinations thereof disclosed in the claims.

An omnidirectional rotation drive device for achieving the above-described objects of the present disclosure includes the following configuration.

In one aspect of the present disclosure, an omnidirectional rotation drive apparatus includes: a knuckle connected to a vehicle body, a main wheel drive shaft rotatably supported on the knuckle, a sub-wheel drive shaft rotatably supported on the main wheel drive shaft, and a wheel body fixed to the main wheel drive shaft to rotate simultaneously with the main wheel drive shaft. The omnidirectional rotation drive apparatus further includes: sub-wheel units rotatably supported on the wheel body, and gear units connected to the sub-wheel drive shaft to transmit rotational force from the sub-wheel drive shaft to the sub-wheel units. In particular, the sub-wheel units are rotated based on an angular velocity difference between the main wheel drive shaft and the sub-wheel drive shaft.

In an embodiment, each of the sub-wheel units may include a plurality of sub-wheels, and central axes of rotation of the plurality of sub-wheels may be perpendicular to a central axis of rotation of the wheel body.

In another embodiment, the sub-wheel units may be arranged to form two rows with the wheel body interposed therebetween in a direction of an axis of rotation of the wheel body.

In still another embodiment, the omnidirectional rotation drive apparatus may further include a first motor configured to rotate the main wheel drive shaft, and a second motor configured to rotate the sub-wheel drive shaft.

In yet another embodiment, each of the gear units may include a first gear connected to the sub-wheel drive shaft, a second gear engaged with the first gear, a third gear engaged with the second gear, a fourth gear engaged with the third gear and connected to a corresponding sub-wheel unit among the sub-wheel units, and a gear unit housing.

In still yet another embodiment, the second gear and the third gear may be arranged so that an axis of rotation of the second gear and an axis of rotation of the third gear are perpendicular to each other.

In a further embodiment, the gear unit housing may be fixed to the wheel body, a rotating shaft of the second gear may be fixed to the gear unit housing, and the second gear may be rotatably supported on the rotating shaft.

In another further embodiment, the omnidirectional rotation drive apparatus may further include support rollers fixed to the wheel body to rotatably support the plurality of sub-wheels.

In still another further embodiment, when the main wheel drive shaft and the sub-wheel drive shaft are rotated at the same angular velocity, only the wheel body may be rotated.

In yet another further embodiment, when the main wheel drive shaft and the sub-wheel drive shaft are rotated at different angular velocities or when the main wheel drive shaft is rotated and the sub-wheel drive shaft is stopped, the wheel body and the sub-wheel units may be rotated simultaneously.

In still yet another further embodiment, when the main wheel drive shaft is stopped and the sub-wheel drive shaft is rotated, only the sub-wheel units may be rotated.

Other aspects and embodiments of the disclosure are discussed infra.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure, and wherein:

FIG. 1 is a perspective view of an omnidirectional rotation drive apparatus according to one embodiment of the present disclosure;

FIG. 2 is a rear perspective view of the omnidirectional rotation drive apparatus according to one embodiment of the present disclosure;

FIG. 3 is a front view of the omnidirectional rotation drive apparatus according to one embodiment of the present disclosure;

FIG. 4 is a cross-sectional view of the omnidirectional rotation drive apparatus according to one embodiment of the present disclosure;

FIG. 5 is a view showing a coupling relationship among a knuckle, a first motor, and a second motor according to one embodiment of the present disclosure;

FIG. 6 is a view showing the coupling structure of a gear unit according to one embodiment of the present disclosure;

FIG. 7 is a side view showing the positional relationship of support rollers according to one embodiment of the present disclosure;

FIG. 8 is a view showing the configuration of sub-wheel units continuously formed on the outer circumferential surface of a wheel body according to one embodiment of the present disclosure; and

FIGS. 9A to 9C are views showing a driving relationship between a main wheel and sub-wheels according to one embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, should be determined in part by the particular intended application and use environment.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below. The present disclosure is not limited to the following embodiments, and the embodiments may be implemented in various different forms. The embodiments are provided to make the description of the present disclosure thorough and to fully convey the scope of the present disclosure to those having ordinary skill in the art.

Further, in the following description of the embodiments, it should be understood that the suffixes “ . . . part”, “ . . . unit”, “ . . . module”, etc. indicate units for processing at least one function or operation, and may be implemented as software, hardware, or a combination of software and hardware.

Further, the terminology used herein is for the purpose of describing particular embodiments only and is not intended to be limiting. As used herein, singular expressions may be intended to include plural expressions as well, unless the context clearly indicates otherwise.

In addition, in the following description of the present disclosure, although the terms “first,” “second,” and the like may be used herein to describe various elements, these terms may be only used to distinguish one element from other elements, and do not imply a sequence or order unless clearly indicated by the context. When a component, device, element, or the like of the present disclosure is described as having a purpose or performing an operation, function, or the like, the component, device, or element should be considered herein as being “configured to” meet that purpose or to perform that operation or function.

In the following description of the present disclosure, a first direction refers to the forward and backward directions of a vehicle. Moreover, the width direction of the vehicle, which is perpendicular to the first direction, is hereinafter referred to as a second direction. Further, if one of the first direction and the second direction is referred to as a positive direction, a negative direction may be interpreted as the direction opposite to the positive direction.

In the description with reference to the accompanying drawings, the same or corresponding components are indicated by the same reference numerals and a redundant description thereof is thus omitted.

The present disclosure relates to an omnidirectional rotation drive apparatus, and more particularly, to a drive apparatus with an omni-structure capable of movement in all directions, including a wheel body 20 that rotates in a first direction and a plurality of sub-wheel units 100 located on the outer circumferential surface of the wheel body 20 that rotate in a second direction. Here, the sub-wheel unit 100 is a concept that includes a plurality of sub-wheels 110 arranged in a single row.

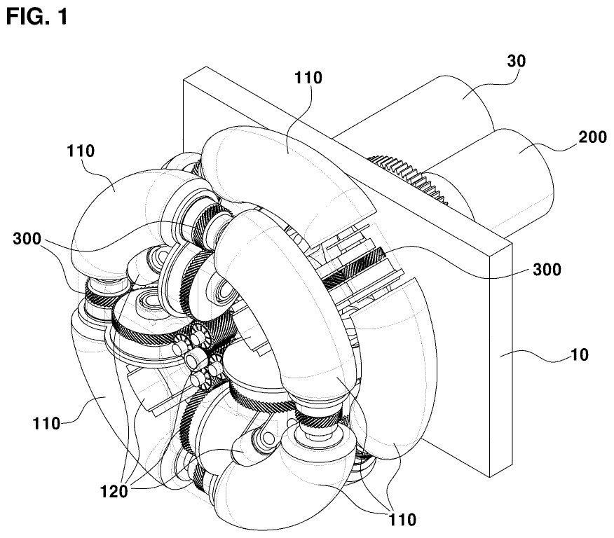

In one embodiment of the present disclosure, as illustrated in FIGS. 1-2 and 4, the omnidirectional rotation drive apparatus includes: a knuckle 10 which is at least partially located on a vehicle, and a first motor 30 which is located on the knuckle 10 to rotate the wheel body 20 about the knuckle 10. More specifically, the wheel body 20 may be located at one end of the knuckle 10, and the first motor 30 includes a stator located on the knuckle 10 and a rotor rotated integrally with the wheel body 20. Otherwise, a main wheel drive shaft 40 coupled to the wheel body 20 may be coupled to the first motor 30 on the inner surface of the knuckle 10 to transmit driving force to the wheel body 20 through the main wheel drive shaft 40.

In addition, the first motor 30 is configured such that the stator of the first motor 30 is fixed to the vehicle body, and if current is applied to rotate the main wheel drive shaft 40 including the rotor of the first motor 30, the rotor and the wheel body 20 are rotated integrally. Further, the wheel body 20 is configured to be rotated in the first direction, and the driving force of the vehicle in the forward and backward directions is applied to the wheel body 20 through the first motor 30.

The wheel body 20 may be positioned through the knuckle 10, and may be coupled to the first motor 30 fixed to the vehicle body. The sub-wheel units 100 are configured to extend outward from the outer circumferential surface of the wheel body 20 in the radial direction thereof so as to be coupled thereto. The sub-wheel units 100 are configured such that a plurality of sub-wheels 110 forming each of the sub-wheel units 100 is rotated in a direction perpendicular to the wheel body 20 by rotational force of a sub-wheel drive shaft 210 located inside the wheel body 20.

Further, a second motor 200 located on the vehicle body is coupled to the sub-wheel drive shaft 210, which passes through the main wheel drive shaft 40, and the driving force of the second motor 200 is transmitted to the sub-wheel units 100 through gear units 300 located between the sub-wheel drive shaft 210 and the sub-wheel units 100.

Each of the sub-wheel units 100 include a plurality of sub-wheels 110 arranged in a single row. More specifically, in one embodiment of the present disclosure, the sub-wheel units 100 may be arranged in two rows and each of the sub-wheel units 100 may include four sub-wheels 110 located in each row.

At least two gear units 300 engaged with one first gear 211 of the sub-wheel drive shaft are arranged in the radial direction of the wheel body 20. In one embodiment of the present disclosure, four gear units 300 extending from the wheel body 20 may be located at intervals of 90 degrees with respect to the central axis of rotation of the wheel body 20. Moreover, the gear units 300 corresponding to first gears 211 of the sub-wheel drive shaft 210 may be located respectively. A shaft including the first gears 211 may be formed integrally with the sub-wheel drive shaft 210, or shafts including the respective first gears 211 may be combined into a component provided separately from the sub-wheel drive shaft 210 and coupled to the sub-wheel drive shaft 210. The gear units 300 may be surrounded with gear unit housings 340, and may be located inside the wheel body 20. The gear unit housings 340 are provided on the inner surface of the wheel body 20 to surround the gear units 300, and the gear unit housings 340 may be located to correspond to the plurality of sub-wheel units 100, respectively.

In one embodiment of the present disclosure, the sub-wheel drive shaft 210 includes two first gears 211 in the longitudinal direction, and two gear units 300 corresponding to the two first gears 211, respectively. In addition, the gear units 300 corresponding to one first gear 211 and the gear units 300 corresponding to the other first gear 211 may be located to be spaced apart from each other by an angle of 45 degrees with respect to the central axis of rotation of the wheel body 20. Therefore, the sub-wheel units 100 engaged with the respective gear units 300 may be arranged in two rows, and the respective gear units 300 may be located such that the sub-wheels 110 alternately located in the adjacent rows are arranged at an angle of 45 degrees with respect to the wheel body 20.

As such, the omnidirectional rotation drive apparatus according to the present disclosure includes the sub-wheel units 100 arranged in at least two rows, and the number of rows of the sub-wheel units 100 corresponds to the number of rows of the gear units 300 provided along the outer circumferential surface of the wheel body 20. Further, the gear units 300 may be configured such that the sub-wheels 110 are rotated in a direction perpendicular to the outer circumferential surface of the wheel body 20, and the sub-wheel units 100 may be arranged in two or more rows.

In addition, the sub-wheel units 100 arranged in two rows on the outer circumferential surface of the wheel body 20 are located in inner and outer areas in the second direction adjacent to the outer circumferential surface of the wheel body 20 to be spaced apart from each other by the same distance. Therefore, when viewed from the side of the wheel body 20, the plurality of sub-wheels 110 of the sub-wheel units 100 arranged in the two rows forms the shape of a continuous circle.

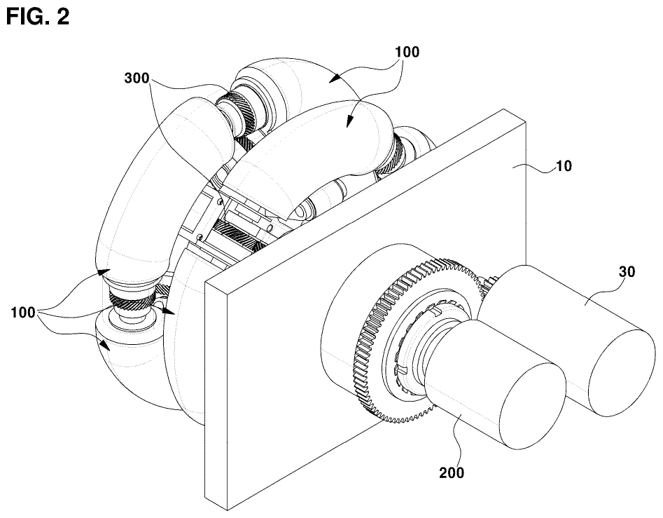

As shown in FIG. 2, a rotating shaft of the first motor 30 may be coupled to the outer circumferential surface of the main wheel drive shaft 40 to rotate the wheel body 20. Moreover, the rotating shaft of the first motor 30 may include any structure having a coupling relationship with the main wheel drive shaft 40 which is capable of transmitting power thereto. For example, the rotating shaft of the first motor 30 and the main wheel drive shaft 40 may include at least one power transmission structure selected from a gear engagement structure, a worm gear engagement structure, a bevel gear engagement structure, chains, and belts.

A rotor of the second motor 200 is coupled to the sub-wheel drive shaft 210, and the sub-wheel drive shaft 210 is located through the center of the main wheel drive shaft 40, and is configured to be rotatable independently of the main wheel drive shaft 40.

Further, the main wheel drive shaft 40 located through the knuckle 10 is configured to be rotatable independently of the knuckle 10 through a bearing located on the inner circumferential surface of the knuckle 10.

Accordingly, the knuckle 10, the main wheel drive shaft 40, and the sub-wheel drive shaft 210 may include various types of bearings on contact surfaces therebetween as to be rotatable independently of each other.

As disclosed above, the omnidirectional rotation drive apparatus may include the sub-wheel units 100 in two rows coupled to the wheel body unit 20 in the second direction along the outer circumferential surface thereof, and the plurality of sub-wheels 110 may be alternately located in the width direction of the outer circumferential surface of the wheel body 20.

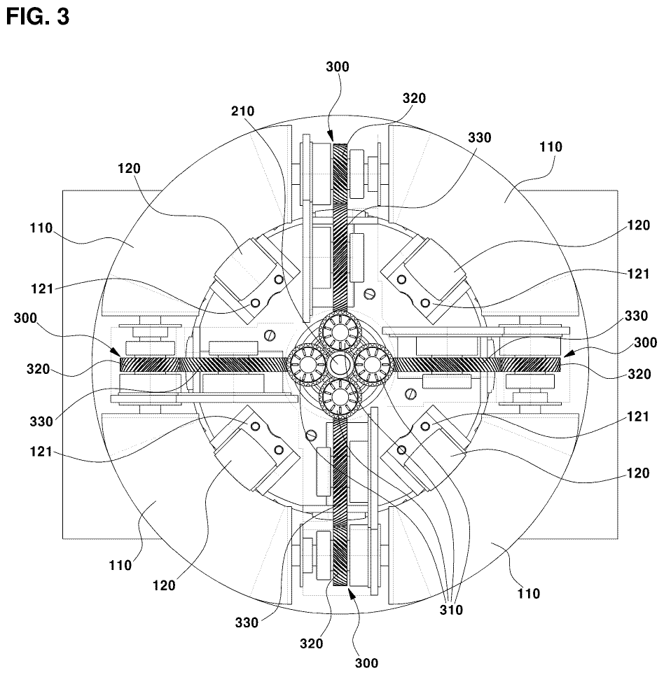

FIG. 3 is a front view of the omnidirectional rotation drive apparatus according to one embodiment of the present disclosure.

The wheel body unit 20 is coupled around the knuckle 10, and at least one sub-wheel unit 100 is located adjacent to the outer circumferential surface of the wheel body unit 20. The sub-wheel unit 110 is coupled to the gear units 300 located inside the wheel body unit 20, and is configured to transmit the rotational force of the sub-wheel drive shaft 210 to the plurality of sub-wheels 110.

Moreover, as shown in this figure, in one embodiment of the present disclosure, the sub-wheel unit 100 forming one row includes four sub-wheels 110 coupled to four gear units 300, respectively, and the four gear units 300 are located at 90-degree intervals, spaced apart from each other. In addition, the sub-wheel unit 100 includes support rollers 120 extending in the second direction of the wheel body 20 and located between the sub-wheels 110 located to be spaced apart from each other.

The support rollers 120 have one end coupled to the wheel body 20, are located in a space between adjacent gear units 300 located in the same row, and support the rear surfaces of the sub-wheels 110 located in the adjacent other row.

Therefore, the support rollers 120 are configured such that one end of each of the support rollers 120 is coupled between adjacent sub-wheels 110 forming one row, and the other end of each of the support rollers 120 supports the rear surface of each of the sub-wheels 110 of the sub-wheel unit 100 arranged in the adjacent other row. Therefore, when the rotational force of the second motor 200 is applied, sagging of the rear surfaces of the sub-wheels 110 located adjacent to the ground may be avoided or prevented.

Furthermore, in one embodiment of the present disclosure, the sub-wheel units 100 arranged in two rows includes support rollers 120 located in each row to support the sub-wheels 110 located in adjacent rows. Therefore, the omnidirectional rotation drive apparatus may include the support rollers 120 extending along both side surfaces of the wheel body 20.

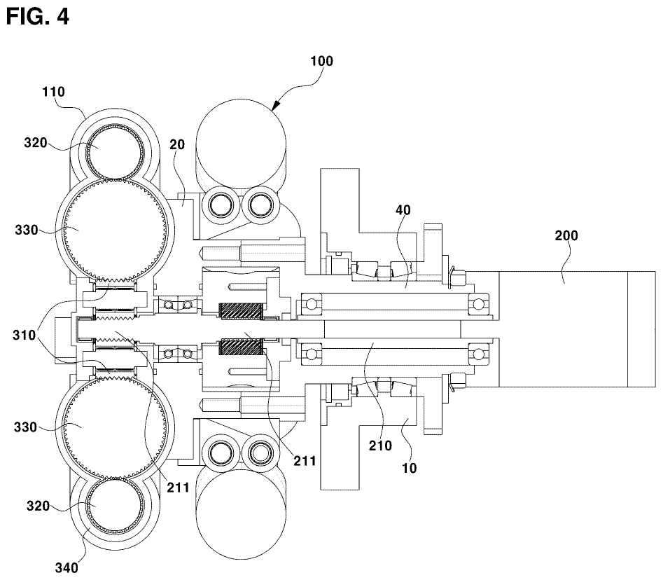

FIG. 4 is a cross-sectional view of the omnidirectional rotation drive apparatus according to one embodiment of the present disclosure.

As shown in FIG. 4, the omnidirectional rotation drive apparatus includes the knuckle 10 fixed to the vehicle body, the main wheel drive shaft 400 located through the knuckle 10, and the sub-wheel drive shaft 210 located through the center of the main wheel drive shaft 40.

The main wheel drive shaft 40 is coupled to the first motor 30 on the inner surface of the knuckle 10, and the sub-wheel drive shaft 210 is coupled to the second motor 200. The first motor 30 and the second motor 200 may be located adjacent to each other on the inner surface of the knuckle 10, the central shaft of the second motor 200 may be directly coupled to the sub-wheel drive shaft 210, and the central shaft of the first motor 30 may be gear-engaged with the main wheel drive shaft 40 to apply driving force thereto.

The sub-wheel drive shaft 210 coupled to the second motor 200 is inserted into the wheel body 20 and extends, and includes two different first gears 211. The first gears 211 are configured such that each of the first gears 211 is coupled to the gear units 300 to transmit rotational force to the sub-wheel units 100 arranged in the two rows.

The gear units 300, respectively coupled to the first gears 211, are coupled to the sub-wheel units 100 arranged in the two rows, respectively, and as the sub-wheel drive shaft 210 including the first gears 211 is rotated, the gear units 300 transmit rotational force to the plurality of sub-wheels 110 arranged in the two rows.

Each gear unit 300 includes a second gear 310 engaged with the first gear 211 of the sub-wheel drive shaft 210, a fourth gear 320 engaged with each sub-wheel 110, and a third gear 330 located between the second gear 310 and the fourth gear 320.

Therefore, if the sub-wheel drive shaft 210 is rotated by the rotational force of the second motor 200, the gear units 300 engaged with the first gears 211 apply the rotational force to the sub-wheels 110, and the sub-wheels 110 are rotated in the second direction using the outer circumferential direction of the wheel body 20 as a central axis. More specifically, both ends of one sub-wheel 110 are coupled to respective gear units 300 so that driving force may be applied to the sub-wheel 110.

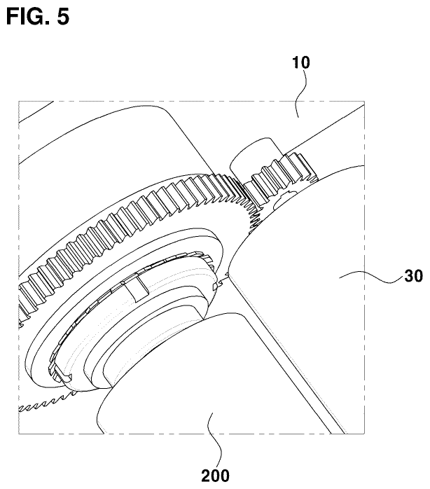

FIG. 5 is a view showing a coupling relationship between the first motor 30 and the second motor 200 located on the inner surface of the knuckle 10 according to one embodiment of the present disclosure.

The first motor 30 is located on the inner surface of the knuckle 10 to be spaced apart from the central axis of rotation of the second motor 200, and is located adjacent to the outer circumferential surface of the main wheel drive shaft 400 protruding from the inner surface of the knuckle 10. In one embodiment of the present disclosure, the main wheel drive shaft 40 has gear teeth formed along the outer circumferential surface of one end thereof protruding from the inner surface of the knuckle 10, and the first motor 30 has gear teeth formed on the central shaft thereof, so that the main wheel drive shaft 40 and the first motor 30 may be coupled to each other. More specifically, the central shaft of the first motor 30 and the main wheel drive shaft 40 may be gear-engaged with each other.

The second motor 200 is located adjacent to the first motor 30, and the rotating shaft of the second motor 200 coincides with the central axis of the sub-wheel drive shaft 210.

The sub-wheel drive shaft 210 passes through the inner surface of the main wheel drive shaft 40 and is coupled to the wheel body 20, so that the sub-wheel drive shaft 210 may be rotated independently of the main wheel drive shaft 40.

More specifically, a ball bearing or a cylindrical bearing may be provided in an area where the knuckle 10 and the main wheel drive shaft 40 contact each other, and a plurality of bearings may be located in an area where the main wheel drive shaft 40 and the sub-wheel drive shaft 210 contact each other.

Accordingly, the knuckle 10, the main wheel drive shaft 40, and the sub-wheel drive shaft 210 may be configured to be rotatable independently of each other.

As such, in one embodiment of the present disclosure, when the first motor 30 and the second motor 200 rotate at the same angular speed, only the wheel body 20 is rotated. In addition, when the first motor 30 rotates and the second motor 200 stops, the wheel body 20 and the plurality of sub-wheels 110 are simultaneously rotated. Furthermore, when the first motor 30 stops and the second motor 200 rotates, only the plurality of sub-wheels 110 is rotated.

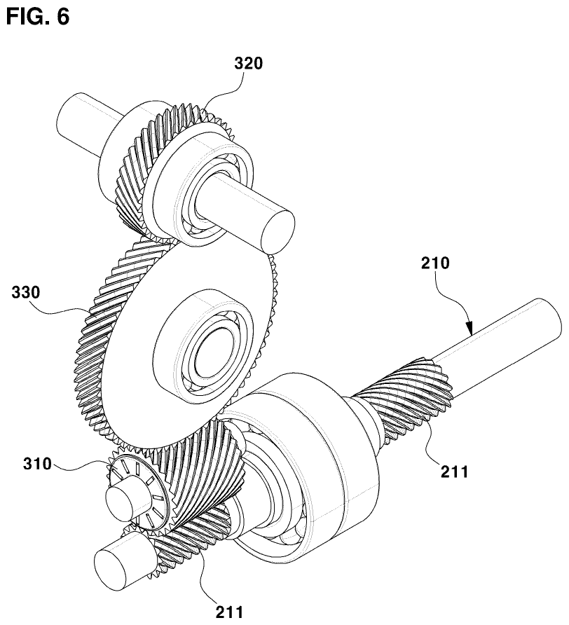

FIG. 6 is a view showing the configuration of the gear unit 300 engaged with the first gear 211 of the sub-wheel drive shaft 210.

In one embodiment of the present disclosure, the sub-wheel drive shaft 210 includes two first gears 211, and the gear units 300 engaged with the respective first gears 211. Each gear unit 300 includes the second gear 310 engaged with the first gear 211 of the sub-wheel drive shaft 210, the fourth gear 320 engaged with the sub-wheel 110, and the third gear 330 located between the second gear 310 and the fourth gear 320.

The two first gears 211 formed on the sub-wheel drive shaft 210 are provided as worm gears located on one shaft, and the first gear 211 is engaged with the second gear 310 and disposed in parallel. More specifically, the first gear 211 and the second gear 310 include helical gear teeth formed in opposite directions, and are engaged with each other by these gear teeth.

The fourth gear 320 is located inside the sub-wheels 110, and is engaged with the third gear 330 located between the second gear 310 and the fourth gear 320. Further, the third gear 330 includes helical gear teeth formed in the same direction as the second gear 310 and is disposed perpendicularly to the second gear 310, and the fourth gear 320 includes helical gear teeth formed in the opposite direction to the third gear 330 and is disposed parallel to the third gear 330. In addition, the fourth gear 320 of one gear unit 300 and the fourth gear 320 of an adjacent gear unit 300 are coupled to both ends of the sub-wheel 110.

In this way, the gear units 300 perform a function of changing the rotational force of the sub-wheel drive shaft 210 by 90 degrees and transmitting the changed rotational force to the respective fourth gears 320, and driving force applied to the sub-wheels 110 may be controlled by controlling the size, number, and radius of the gear teeth forming the first gears 211 of the sub-wheel drive shaft 210 and the gear units 300.

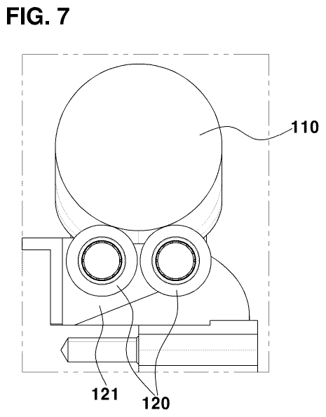

FIG. 7 is a side view showing the configuration of the support rollers 120 according to one embodiment of the present disclosure.

The sub-wheel units 100 are arranged in two rows in inner and outer areas in the second direction on the outer circumferential surface of the wheel body 20, and the sub-wheel unit 100 located in one row includes the support rollers 120 which are coupled to a bracket 121 extending from the wheel body 20 and support the rear surfaces of the sub-wheels 110 located on the other row.

The support rollers 120 may be located to contact the outer circumferential surface of the sub-wheel 110, and may support force applied from the sub-wheel 110 along the central axis of the wheel body 20. More specifically, two support rollers 120 may be located adjacent to each other to contact the outer circumferential surface of the sub-wheel 110.

The bracket 121 may extend along one side of the wheel body 20 with respect to the support rollers 120. Further, the bracket 121 is configured to be located between two adjacent sub-wheels 110 of the sub-wheel unit 100 in one row to support the rear surface of the sub-wheel 110 located on the adjacent other row. In other words, the bracket 121 may be located in a gap between two adjacent sub-wheels 110 located in one row, and the support rollers 120 located at the end of the bracket 121 may be coupled to the sub-wheel 110 located in the other row. Moreover, the support rollers 120 may extend along both sides of the wheel body 20 and be located on all of the plurality of sub-wheels 110 of the sub-wheel units 100 arranged in the two rows.

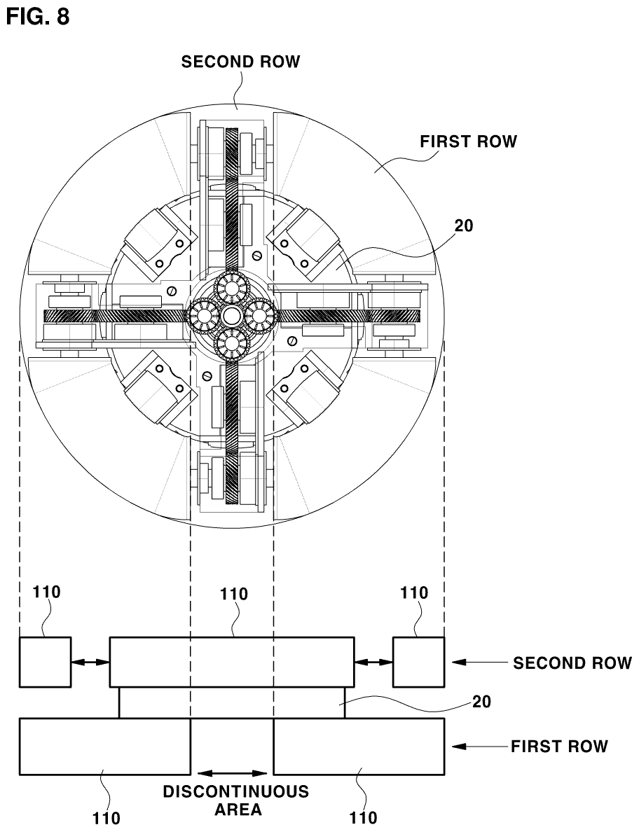

FIG. 8 is a side view of the omnidirectional rotation drive apparatus, to which the sub-wheels 110 are coupled, according to one embodiment of the present disclosure.

As shown in FIG. 8, the omnidirectional rotation drive apparatus includes the sub-wheel units 100, each of which includes four sub-wheels 110 arranged in one row, and both ends of each sub-wheel 110 are coupled to the fourth gears 320 of the gear unit 300. A discontinuous area is provided in an area provided between adjacent sub-wheels 110 located in the same row, to which the fourth gear 320 is coupled, in the rotating direction of the wheel body 20.

However, the sub-wheel unit 100 in the other row located adjacent to the sub-wheel unit 100 forming the one row includes four sub-wheels 110 which alternate with the sub-wheels 110 arranged in the one row in the width direction of the wheel body 20. In other words, the sub-wheels 110 located in the adjacent other row are located at an angle of about 45 degrees with the sub-wheels 110 located in the one row in the radial direction of the wheel body 20 with respect to the wheel body 20, and the discontinuous area between adjacent sub-wheels 110 in the one row, to which the fourth gear 320 is coupled, becomes a continuous area due to the sub-wheels 110 located in the other row, as viewed from the side.

Accordingly, the sub-wheel units 100 arranged in two or more rows along the outer circumferential surface of the wheel body 20 are configured to have a continuous circular shape surrounding the outside of the wheel body 20. Therefore, due to the structure of the sub-wheels 110 alternately located in the inner and outer areas of the wheel body 20, the sub-wheel units 100 may provide a continuous circular shape on the side of the wheel body 20.

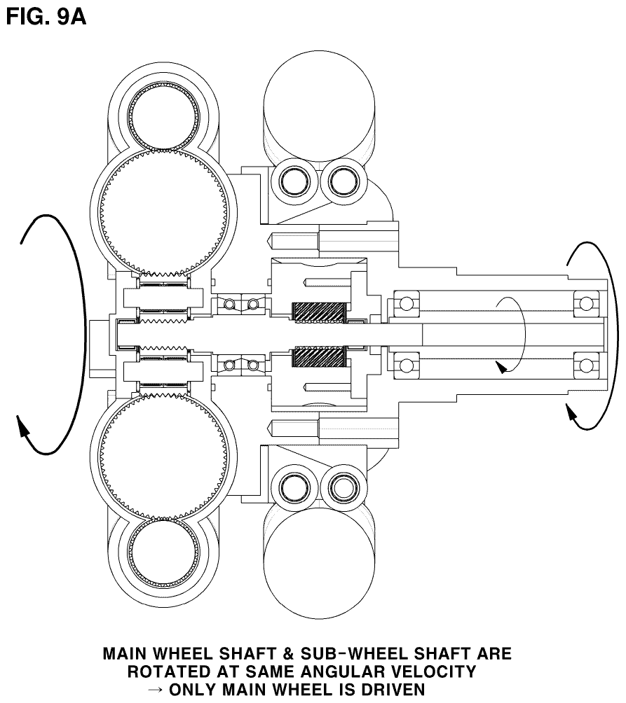

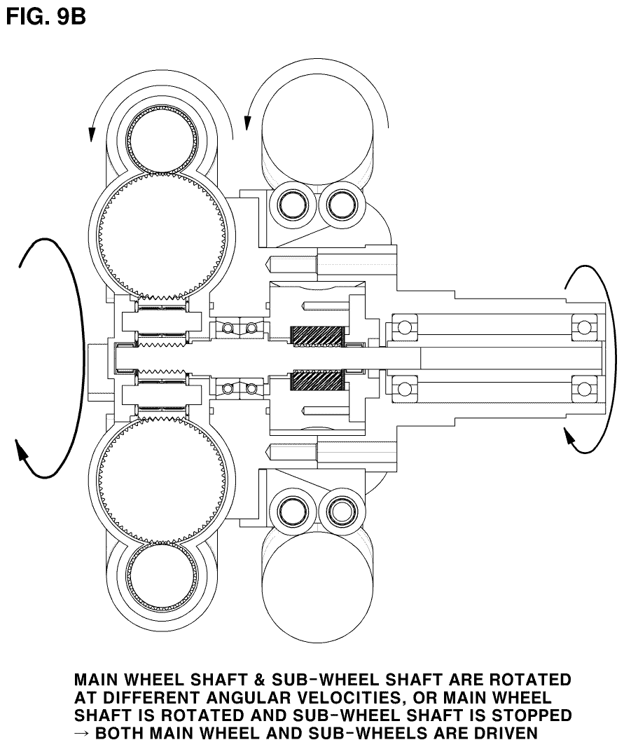

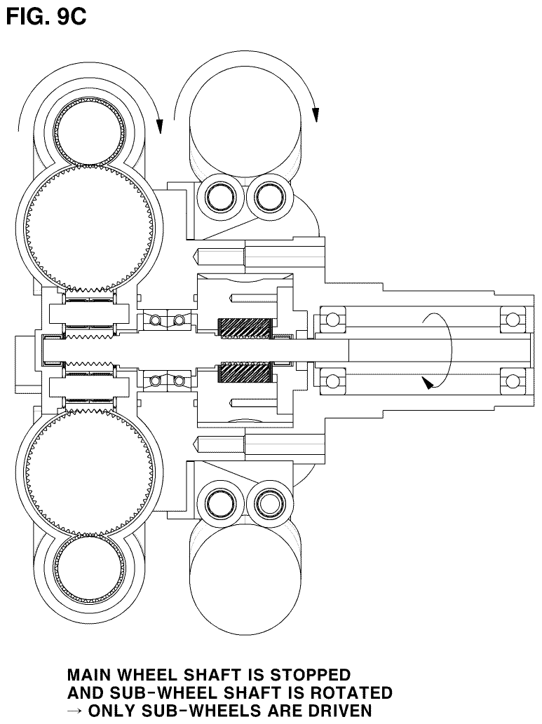

FIGS. 9A to 9C are views showing a driving relationship between a main wheel (i.e., the wheel body 20), and sub-wheels (i.e., the sub-wheel units 100) due to an angular velocity difference between the first motor and the second motor.

As shown in FIG. 9A, if the first motor and the second motor rotate at the same angular speed, the rotation speed of the main wheel drive shaft and the rotation speed of the sub-wheel drive shaft are the same. Accordingly, only the wheel body 20 is rotated depending on the angular speed of the first motor.

In addition, as shown in FIG. 9B, if the first motor and the second motor have different angular velocities, the wheel body 20 is rotated depending on the angular velocity of the first motor, and the sub-wheel units 100 are controlled to be rotated at a speed corresponding to an angular velocity difference between the first motor and the second motor.

In other words, if the angular velocities of the first motor and the second motor are different, a driving path having a predetermined angle with respect to the rotation direction of the wheel body 20 may be set.

Referring to FIG. 9C, if the first motor is not driven and the second motor has a designated angular velocity, the sub-wheel units 100 are rotated at a speed corresponding to the angular velocity of the second motor. Further, the vehicle may travel to the right or left in the figure depending on the rotation direction of the second motor.

In addition, the sub-wheel units 100 driven, as shown in FIGS. 9B and 9C, may be configured to be rotated along both sides of the wheel body 20 depending on the number of gears of the gear units 300 and the driving direction of the second motor.

As is apparent from the above description, the present disclosure may obtain the following effects through the configuration, combination and usage relations disclosed in the above-described embodiments.

The present disclosure provides an omnidirectional rotation drive apparatus that includes gear units coupled to the inside of a wheel body and applies driving force to sub-wheels arranged in two rows, which are coupled to a plurality of gear areas and located perpendicularly on the outer circumferential surface of the wheel body.

In addition, the present disclosure has the effect of being able to freely set the driving direction of a vehicle through the omnidirectional rotation drive apparatus having an omni-wheel structure capable of driving in the first direction and/or the second direction.

Further, the present disclosure provides sub-wheel driving conditions using the gear units, thereby having the effect of designing the driving apparatus to have a compact size.

The above detailed description is illustrative of the present disclosure. In addition, the above description is intended to illustrate the exemplary embodiments of the present disclosure, the present disclosure may be used in various other combinations, modifications, and environments. In other words, it should be apparent to those having ordinary skill in the art that various substitutions, changes and modifications, which are not exemplified herein but are still within the spirit and scope of the present disclosure, may be made. The described embodiments illustrate the best mode for implementing the technical idea of the present disclosure, and various changes required for specific application fields and uses of the present disclosure are also possible. Accordingly, the above detailed description of the disclosure is not intended to limit the present disclosure to the disclosed embodiments. Further, the appended claims should be construed to include other embodiments as well.

What is claimed is:

1. An omnidirectional rotation drive apparatus comprising:
a knuckle connected to a vehicle body;
a main wheel drive shaft rotatably supported on the knuckle;
a sub-wheel drive shaft rotatably supported on the main wheel drive shaft;
a wheel body fixed to the main wheel drive shaft to rotate simultaneously with the main wheel drive shaft;
sub-wheel units rotatably supported on the wheel body; and
gear units connected to the sub-wheel drive shaft to transmit rotational force from the sub-wheel drive shaft to the sub-wheel units,
wherein the sub-wheel units are rotated based on an angular velocity difference between the main wheel drive shaft and the sub-wheel drive shaft.

2. The omnidirectional rotation drive apparatus of claim 1, wherein:
each of the sub-wheel units comprises a plurality of sub-wheels; and
central axes of rotation of the plurality of sub-wheels are perpendicular to a central axis of rotation of the wheel body.

3. The omnidirectional rotation drive apparatus of claim 1, wherein the sub-wheel units are arranged to form two rows with the wheel body interposed therebetween in a direction of an axis of rotation of the wheel body.

4. The omnidirectional rotation drive apparatus of claim 1, further comprising:
a first motor configured to rotate the main wheel drive shaft; and
a second motor configured to rotate the sub-wheel drive shaft.

5. The omnidirectional rotation drive apparatus of claim 1, wherein each of the gear units comprises:
a first gear connected to the sub-wheel drive shaft;
a second gear engaged with the first gear;
a third gear engaged with the second gear;
a fourth gear engaged with the third gear and connected to a corresponding sub-wheel unit among the sub-wheel units; and
a gear unit housing.

6. The omnidirectional rotation drive apparatus of claim 5, wherein the second gear and the third gear are arranged so that an axis of rotation of the second gear and an axis of rotation of the third gear are perpendicular to each other.

7. The omnidirectional rotation drive apparatus of claim 5, wherein:
the gear unit housing is fixed to the wheel body; and
a rotating shaft of the second gear is fixed to the gear unit housing, and the second gear is rotatably supported on the rotating shaft.

8. The omnidirectional rotation drive apparatus of claim 2, further comprising:
support rollers fixed to the wheel body to rotatably support the plurality of sub-wheels.

9. The omnidirectional rotation drive apparatus of claim 1, wherein, when the main wheel drive shaft and the sub-wheel drive shaft are rotated at the same angular velocity, only the wheel body is rotated.

10. The omnidirectional rotation drive apparatus of claim 1, wherein, when the main wheel drive shaft and the sub-wheel drive shaft are rotated at different angular velocities or when the main wheel drive shaft is rotated and the sub-wheel drive shaft is stopped, the wheel body and the sub-wheel units are rotated simultaneously.

11. The omnidirectional rotation drive apparatus of claim 1, wherein, when the main wheel drive shaft is stopped and the sub-wheel drive shaft is rotated, only the sub-wheel units are rotated.
